(19) United States
(12) Patent Application Publication
(10) Pub. No.: US 2014/0221208 A1
(43) Pub. Date: Aug. 7, 2014

(54) CONTROLLED RELEASE COPPER SULFATE FOR PHYTOPLANKTON CONTROL

(71) Applicants: Garrard L. Hargrove, Birmingham, AL (US); Robert Scott Wilson, Sterrett, AL (US)

(72) Inventors: Garrard L. Hargrove, Birmingham, AL (US); Robert Scott Wilson, Sterrett, AL (US)

(73) Assignee: AGRIUM ADVANCED TECHNOLOGIES

(21) Appl. No.: 13/981,786

(22) PCT Filed: Jan. 20, 2012
(86) PCT No.: PCT/US12/22009

§ 371 Date: Dec. 4, 2013

Related U.S. Application Data
(60) Provisional application No. 61/435,920, filed on Jan. 25, 2011.

(51) Int. Cl. A01N 59/20; C02F 1/50; A23L 1/325

(52) U.S. Cl. CPC A01N 59/20; A23L 1/325; C02F 1/505; C02F 2305/14; C02F 2303/04
USPC 504/152; 426/643; 427/221; 427/214

(57) ABSTRACT

A controlled release copper sulfate algaecide for controlling phytoplankton growth, including blue green algae is described. The controlled release algaecide includes a copper sulfate granule coated with at least one layer including a polyurethane which is a reaction product of a polymeric diisocyanate and a polyol.

### PRIORITY CLAIM

This application claims the benefit of U.S. Provisional Patent Application Ser. No. 61/435,920 filed Jan. 25, 2011, entitled CONTROLLED RELEASE COPPER SULFATE FOR PHYTOPLANKTON CONTROL, the disclosure of which is incorporated herein by reference.

### TECHNICAL FIELD

This disclosure generally relates to treatments for controlling phytoplankton growth in a body of water. More particularly, this disclosure relates to controlled release copper sulfate treatments for controlling phytoplankton growth, including blue-green algae growth, in aquaculture ponds.

### BACKGROUND

A problem in aquaculture is the development of an off-flavor in edible fish and shrimp meat resulting from odorous compounds produced by certain species of blue-green algae in ponds. Odorous compounds such as geosmin and methylisoborneol are excreted into the water by blue-green algae and absorbed by fish, accumulating in their tissue. Pond-reared channel catfish are especially susceptible to off-flavor problems. Some species of blue-green algae also may be toxic to fish, and dense phytoplankton blooms often result in low, nighttime dissolved oxygen concentration.

Blue-green algae are favored over other algae species by elevated pH. Dense blooms of phytoplankton in nutrient-rich aquaculture ponds cause elevated pH, and blue-green algae typically become dominant in freshwater aquaculture ponds. The most common method for controlling blue-green algae and phytoplankton blooms in ponds is the periodic application of copper sulfate (CuSO₄.5H₂O) at a concentration equal to 1% of the total alkalinity. Ponds often are treated several times per growing season with copper sulfate. Copper sulfate is usually pre-dissolved in water, and the solution is distributed over the pond surface from a boat—a procedure that requires considerable effort and time. The elevated copper concentrations resulting from copper sulfate treatment quickly return to pre-treatment levels within a few days, and repeated application of copper sulfate is often necessary.

### SUMMARY

In one embodiment, the present invention is a controlled release algaecide comprising a copper sulfate granule coated with at least one layer including a polyurethane. The polyurethane is the reaction product of a polymeric diisocyanate and a polyol. The controlled release copper sulfate algaecide can be used in a variety of bodies of water including, but not limited to, the following: lakes, wetlands, ponds, aquaculture ponds, ornamental ponds, swimming pools, cisterns, irrigation reservoirs, irrigation canals, drinking water reservoirs, water treatment reservoirs, rice production systems, and other bodies of water where phytoplankton growth may be a concern.

In another embodiment, the present invention is a method of manufacturing a controlled release algaecide including the steps of: a) heating copper sulfate granules to a temperature of about 150° F.; b) contacting the granules with a polymeric diisocyanate; c) contacting the granules with a polyol; and d) forming a controlled release coating on the granules.

In yet another embodiment, the present invention is a method of controlling phytoplankton growth in a body of water including the steps of: suspending a porous container containing a controlled release algaecide below the surface of the body of water, wherein the controlled release algaecide comprises a copper sulfate granule coated with at least one layer including a polyurethane comprising a reaction product of a polymeric diisocyanate and a polyol; and maintaining the porous container containing the controlled release algaecide in the body of water for an extended period of time.

In yet another embodiment, the present invention is a method of controlling phytoplankton growth in a body of water comprising contacting the body of water with a coated copper sulfate granule to control phytoplankton growth for at least one week, wherein the coated copper sulfate granule has at least one polyurethane layer comprising a reaction product of a polymeric diisocyanate and a polyol.

In still yet another embodiment, the present invention is a food product including one or more food products derived from a fish or shellfish raised in an aquaculture pond treated with a controlled release copper sulfate algaecide to prevent an off-taste in the food product.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIGS. 1-9 are a series of bar graphs comparing a selected treatment to a control for a series of variables for each sampling date.

### DETAILED DESCRIPTION

A controlled release algaecide, such as described herein according to the various embodiments, can be used to control the growth of phytoplankton and, in particular blue-green algae, in a body of water over an extended period of time. More particularly, the controlled release algaecide, as described herein, can be used to control phytoplankton growth, and in particular, blue-green algae growth, in bodies of water for extended periods of time, with only one application at about half the rate required for the same algae control from non-controlled release copper sulfate.

The controlled release algaecide, as described herein according to the various embodiments, can be used to treat both fresh water and salt water bodies of water. Exemplary bodies of water that can be treated with the controlled release algaecide, as described herein, include, but are not limited to, the following: lakes, wetlands, ponds, aquaculture ponds, ornamental ponds, swimming pools, cisterns, irrigation reservoirs, irrigation canals, drinking water reservoirs, water treatment reservoirs, rice production systems, and other bodies of water where phytoplankton growth may be a concern.

The controlled release algaecide, as described herein according to the various embodiments, can be used to treat freshwater or saltwater aquaculture ponds used to raise fish and shellfish for commercial sale and consumption. Controlling the growth of phytoplankton, including blue-green algae, in the aquaculture ponds used to raise fish and shellfish prevents an off-taste in the resulting commercial product. Exemplary fish and shellfish that can be raised in aquaculture ponds that have been treated with the controlled release algaecide, as described herein, can include, but are not limited to, the following: catfish, carp, salmon, tilapia, trout, walleye, perch, shrimp, clams, oysters, mussels, and scallops. Certain aquatic plants such as, for example, seaweed, can also be produced in aquaculture ponds that have been treated with the controlled release algaecide, as described herein, for commercial sale.

The effectiveness of a controlled release copper sulfate algaecide, as described herein, was compared with that of uncoated copper sulfate, the algaecide normally used in aquaculture ponds. The controlled release copper sulfate algaecide released copper for about 10 weeks. Initially, concentrations of copper in ponds treated with the controlled release algaecide were similar or greater than those in ponds receiving weekly applications of uncoated copper sulfate. After three weeks, ponds receiving uncoated copper sulfate had higher concentrations of copper than were observed in ponds treated with the controlled release product. Phytoplankton (including blue-green algae) abundance was, nevertheless, no greater in the ponds to which the controlled release product was applied than in ponds treated weekly with uncoated copper sulfate. The controlled release copper sulfate algaecide appears to be an effective method for controlling phytoplankton in aquaculture ponds, and is easier to apply than uncoated copper sulfate.

According to the various embodiments of the present invention, the controlled release algaecide includes coated copper sulfate (CuSO₄) granules. The coated copper sulfate granules may include up to five waters of hydration (e.g., CuSO₄.5H₂O). The coating used to coat the copper sulfate granules includes one or more layers, at least one of which is a polyurethane layer. According to various embodiments, the polyurethane used to coat the granules is a reaction product of an isocyanate and a polyol. The polyurethane is formed in situ on the surface of the granules during the coating process, which is described in greater detail below.

Isocyanates contain two or more -NCO groups available for reaction and, as known to one skilled in the art, are widely used in the production of urethane polymers. The isocyanate used to react with the polyol to produce the polyurethane layer is not to be restricted. Some examples of suitable isocyanates include, but are not limited to, the following: 1,6-hexamethylene diisocyanate, 1,4-butylene diisocyanate, furfurylidene diisocyanate, 2,4-toluene diisocyanate (TDI), 2,6-toluene diisocyanate (2,6-TDI), 2,4′-diphenylmethane diisocyanate, 4,4′-diphenylmethane diisocyanate (MDI), 4,4′-diphenylpropane diisocyanate, 4,4′-diphenyl-3,3′-dimethyl methane diisocyanate, 1,5-naphthalenediisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitoluene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof. In one embodiment, the isocyanate used to produce the polyurethane layer is 2,4-toluene diisocyanate (TDI). In another embodiment, the isocyanate used to produce the polyurethane layer is 4,4′-diphenylmethane diisocyanate (MDI). In still yet another embodiment, the isocyanate is polymeric methyl diphenyl diisocyanate (pMDI).

A polyol is a compound containing two or more hydroxyl groups available for reaction. The polyol used to react with the isocyanate to produce the polyurethane layers is not to be restricted. The polyol can be any hydroxyl-containing compound or mixture of hydroxyl-containing compounds including, but not limited to, the following: polyethers, polyesters, epoxys, polycarbonates, polydienes, polycaprolactones, and vegetable derived polyols.

In one embodiment, the polyol is a vegetable oil derived polyol. Vegetable oil derived polyols are also sometimes referred to as oleo polyols or triglycerides. According to some embodiments of the present invention, the polyol is an oleo polyol. In some embodiments, the polyol includes reaction products of esters containing double bonds with any one of soybean oil, sunflower oil, castor oil, canola oil, corn oil, safflower oil, tall oil, tallow, and mixtures thereof. Exemplary commercially available vegetable oil derived polyols include castor oil and AGROL®. In further embodiments, the polyol is a cross-linked oleo polyol that is cross-linked with either sulfur, oxygen, and/or a peroxide cross-linking moiety.

In another embodiment, the polyol is a polyester polyol. Exemplary polyester polyols include INVISTA'S TERATE® 258; STEPAN'S STEPANPOL® PS-2352; and COIM'S ISOEXTER® 4404-US, among others. In another embodiment, the polyol is a blend of polyols. For example, in one embodiment, the polyol can be a blend containing a polyester polyol and triethanolamine (TEA). In a further embodiment, the polyol blend includes 90 wt. % polyester polyol and 10 wt. % TEA.

In still other embodiments the polyol includes a mixture of at least one monoglyceride and/or at least one diglyceride, and is cross-linked with a sulfur, oxygen and/or a peroxide cross-linking moiety. Suitable cross-linked polyols are shown and described in U.S. Provisional Application No. 61/412,251 entitled, “Controlled Release Fertilizers Made From Cross -Linked Glyceride Mixtures”, filed on Nov. 10, 2010, which is incorporated herein by reference in its entirety for all purposes.

In some embodiments, the coating may also include at least one layer of a wax. The wax layer can be formed from a single type of wax or a mixture of different waxes. Non-limiting examples of suitable waxes include an intermediate petroleum wax, an alpha olefin wax, a polyethylene wax, a paraffin wax, a silicone wax, a slack wax, a microcrystalline wax, or a natural wax. In one embodiment, the wax is a C_{30+HA} alpha olefin wax.

A parting agent may be incorporated into at least one of the coating layers (polyurethane layer and/or wax layer) to keep the particles from agglomerating during the coating process. There are several parting agents that are suitable for use with the present invention according to the various embodiments. In one embodiment, the parting agent is precipitated silica.

The controlled release algaecide is effective in controlling the growth of phytoplankton and more particularly, blue-green algae, over an extended period of time. In one embodiment, the controlled release algaecide, as described herein according to the various embodiments, is effective in controlling the growth of phytoplankton, including blue-green algae, for a period of time of at least three weeks. In another embodiment, the controlled release algaecide, as described herein according to the various embodiments, is effective in controlling the growth of phytoplankton, including blue-green algae, for a period of time of up to about ten weeks. In still another embodiment, the controlled release algaecide, as described herein according to the various embodiments, is effective in controlling the growth of phytoplankton, including blue-green algae, for a period of time of up to about three months. In still yet another embodiment, the controlled release algaecide, as described herein according to the various embodiments, is effective in controlling the growth of phytoplankton, including blue-green algae, for a period of time of up to about six months.

The amount of time over which the copper sulfate is released can be controlled by controlling the number of coating layers, the coating thickness, and/or the total weight of the coating. In one embodiment, the coating can include up to thirty layers. Additionally, in some embodiments, the total weight of the coating can range from about 15 wt. % to about 25 wt. % (weight of the coating/weight of the coating +weight of the granule). In another embodiment, the coating is present in an amount of about 20 wt. %.

According to some embodiments, an aquaculture pond or other body of water can be treated with the controlled release algaecide, as described herein according to the various embodiments, by contacting the aquaculture pond or other body of water with the controlled release algaecide to control phytoplankton growth. The pond or other body of water is contacted with the controlled release algaecide using those same methods used to apply a non-controlled release copper sulfate and other water treatments. The controlled release algaecide can be re-applied at regular intervals as determined by the abundance of phytoplankton in the pond or other body of water. In one embodiment, the coated copper sulfate granules are brought into contact with the surface of the pond or other body of water to control phytoplankton growth for at least one week. In another embodiment, the coated copper sulfate granules are brought into contact with the surface of the pond or other body of water to control phytoplankton growth for a period of time of up to ten weeks. In still another embodiment, the coated copper sulfate granules are brought into contact with the surface of the pond or other body of water to control phytoplankton growth for a period of time of up to about six months.

According to other embodiments, an aquaculture pond or other body of water can be treated with the controlled release algaecide, as described herein according to the various embodiments, by suspending a porous container such as for example, a mesh bag, containing the coated copper sulfate granules below the surface of the aquaculture pond or other body of water and maintaining the container including the coated granules in the pond or other body of water for at least one week. In one embodiment, the controlled release algaecide is maintained in the aquaculture pond or other body of water for a period of time of up to about 10 weeks before another treatment is needed. In another embodiment, the controlled release algaecide is maintained in the aquaculture pond or other body of water for a period of time of up to about 3 months before another treatment is needed. In still yet another embodiment, the controlled release algaecide is maintained in the aquaculture pond or other body of water for a period of time of up to about six months before another treatment is needed.

The total amount of copper in the controlled release algaecide to be applied to the aquaculture pond depends on the size of the aquaculture pond to be treated, the alkalinity of the pond, and the phytoplankton abundance in the pond. In one embodiment, the total amount of copper applied to the aquaculture pond using the controlled release algaecide as described herein ranges from about 750 g/pond to about 2,000 g/pond and more particularly, from about 750 g/pond to about 1,500 g/pond.

A method of producing the controlled release algaecide will now be described. A desired amount of copper sulfate pentahydrate granules are deposited into a coating drum. The copper sulfate pentahydrate granules are heated to 150° F. Next, an isocyanate is introduced into the coating drum and time is allowed for the isocyanate to spread on the copper sulfate pentahydrate granules. A polyol is then introduced into the coating drum and allowed to spread on the isocyanate covered copper sulfate pentahydrate granules. As the polyol spreads, it will react with the isocyanate to begin to form a polyurethane layer on the granules. After enough time has elapsed for the polyol to spread completely, a final addition of isocyanate is introduced into the coating drum to spread and complete the formation of the polyurethane layer. A parting agent may also be introduced after the second isocyanate addition to minimize agglomeration. A wax layer may also be formed after addition of the parting agent by introducing a wax into the coating drum. These steps can be repeated until a desired number of coating layers are formed. The temperature of the granules is maintained at 150° F. during the entire coating process. The granules are maintained at 150° F. for an additional amount of time after the various layers have been formed to cure the coating. The coated granules are then cooled and removed from the coating drum.

### EXAMPLES

### Example 1

### Preparation of a Coated Copper Sulfate Product

4.8 kg of copper sulfate pentahydrate (CuSO₄.5H₂O) granules (Size 10XL(90—5+10 mesh) from Pestel minerals, Canada) were transferred to a coating drum operated at 30 rpm and heated to, and maintained at, a temperature of 150° F. The copper sulfate granules were coated by reacting on their surface pMDI (NCO content, 31-33 wt. %; equivalent wt., 130-133 grams; functionality 2.4-2.8; viscosity at 25° C., cps: 50-200) with a polyol blend of 90% polyester polyol (equivalent wt., grams 220-250; viscosity at 25° C., cps: 2000-4500; functionality 2) and 10% triethanolamine (97 wt/% minimum). This was followed by the application of precipitated silica (ZEOFREE® 5161, Huber Engineered Materials) as a parting agent. The sequence to which the various coating components were added to the coating drum to coat the copper sulfate granules is provided below in Table 1.

TABLE 1
Coating sequence used to coat the copper sulfate granules.

| | |
|---|---|
| Amount | Applied at |
| Applied, | Time Indicated |

| Layer | Component | grams | Minutes | Seconds |
|---|---|---|---|---|
| 1 | pMDI | 5.94 | 0 | 0 |
| | Polyol blend | 17.8 | 0 | 45 |
| | pMDI | 8.9 | 2 | 15 |
| | Precipitated silica | 1.71 | 2 | 40 |
| 2 | pMDI | 5.94 | 3 | 0 |
| | Polyol blend | 17.8 | 3 | 45 |
| | pMDI | 8.9 | 5 | 15 |
| | Precipitated silica | 1.71 | 5 | 40 |

These steps were repeated until a total of twenty-eight polyurethane/precipitated silica layers were fowled on the granules. During the application of the twenty-eight polyurethane/precipitated silica layers, 6.86 grams of wax (C_{30+HA}, CP Chemicals) was applied after the formation of layers 4, 7, 11, 15, 19, 23, and 27. After the formation of the final layer, layer 28, was completed, a post cure was carried out for 5 minutes at 150° F. The product was then cooled to 115° F. and removed from the coating drum. The total amount of coating applied was 17.4 wt. %.

### Example 2

### Efficacy Testing of a Coated Copper Sulfate Product to Control Phytoplankton Growth

### Materials and Methods

A study was conducted over a period of about fifteen weeks in twenty ponds on the E. W. Shell Fisheries Center at Auburn University. Fifteen ponds were 400 m² in area and five were 200 m² in area. The larger ponds had an average depth of approximately 1.0 m, while the smaller ponds had an average depth of approximately 0.75 m. Three treatments were evaluated: uncoated copper sulfate; low rate of coated copper sulfate; and high rate of coated copper sulfate. Each treatment was applied to five, 400 m² ponds. The treatment for each pond was randomly selected by the ballot method—a slip of paper with a pond number was drawn from one jar and a slip with a treatment for this pond was drawn from a second jar. The smaller, 200 m² ponds were used as controls.

Ponds were treated at 5 g/m² with 20-20-5 (% N-% P₂O₅-% K₂O) fertilizer at two-week intervals in order to provide high nutrient concentrations and favor dense phytoplankton abundance. Coated copper sulfate (20 wt. % copper) was provided by Agrium. The method for producing a coated copper sulfate product is described above in Example 1. Uncoated copper sulfate (25 wt. % copper) was purchased from a local feed-and-seed store. Low and high rates for coated copper sulfate were 750 g and 1,500 g per pond.

The treatment rate for the uncoated copper sulfate treatments was based upon the average alkalinity of the ponds (39.25 mg/L) at the beginning of the study. The treatment rates in terms of total copper applied were: control, 0 g/pond; low-coated copper sulfate, 150 g/pond (0.375 g/m²); high-coated copper sulfate, 300 g/pond (0.750 g/m²); and uncoated copper sulfate, 550 g/pond (1.38 g/m²).

The quantity of coated product for each pond was divided into three equal aliquots, and each aliquot was placed in a nylon bag having a mesh size small enough to retain the smallest granules of the coated product. The bags were suspended at a depth of 30 cm beneath the water surface in each pond. Uncoated copper sulfate was applied weekly at a rate of 157 g/pond for a total of fourteen applications (2,198 g/pond).

The ponds were not stocked with fish, and mechanical aeration was not applied. The application of the coated product and the application of uncoated copper sulfate were initiated on the same date. The last uncoated copper sulfate application was applied approximately fifteen weeks later.

Pond waters were analyzed weekly for pH (electronic pH meter and glass electrode), water temperature (thermistor), Secchi disk visibility, specific conductance (conductivity meter), turbidity (nephelometer), chlorophyll a (acetone-methanol extraction and spectrophotometry), and dissolved oxygen (polarographic oxygen meter). Analyses of most variables were initiated about a week after the initial application of the treatments, but analyses for specific conductance and pH were not initiated until about five weeks later. Water analyses followed standard protocol recommended in Eaton et al. “Standard Methods for Examination of Water and Wastewater” 21^{st} edition: 2005 American Public Health Association, Washington D. C. Soluble copper concentration in each of the ponds was measured weekly beginning at about two weeks after the initial application of the treatments using the Hach Porphyrin Method (Hach Chemical Company, Loveland, Colorado) to develop a copper-induced color in the samples. The color was evaluated with a standard spectrophotometer rather than a Hach kit spectrophotometer.

Phytoplankton abundance and the percentage blue-green algae in the phytoplankton communities were measured at 2-week intervals. Algae in samples were preserved with Lugol's Solution, and algae were enumerated microscopically at 100× with aid of a Sedwick-Rafter counting cell.

### Efficacy Study Results

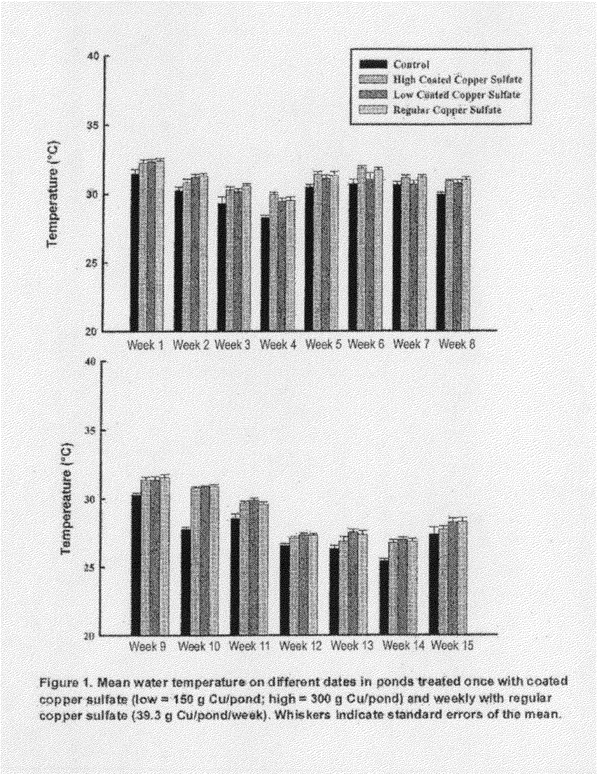

The study results are presented in a series of bar graphs (FIGS. 1-9) comparing a selected treatment to a control for a series of variables for each sampling interval. The standard error of the mean (s _{x̅}) is provided as a whisker extending upward from the middle of each bar (FIGS. 1-9). The grand means for each variable are listed in Table 2 along with a statistical comparison of means for significance (P=0.05) by Duncan's Multiple Range Test.

TABLE 2
Results of tests of grand means of water quality variables
for significance (P = 0.05) by the Duncan's Multiple
Range Test. Means indicated by the same letter are not different.

| | Secchi | | | | |
|---|---|---|---|---|---|
| | disk | DO | Temperature | | Conductance |
| Treatment | (cm) | (mg/L) | (° C.) | pH | (μmhos/cm) |
| Control | 20 a | 6.90 | 29.01 | 9.02 a | 102 |
| High coated | 67 b | 5.97 | 29.92 a | 8.84 b | 113 a |
| CuSO₄ | | | | | |
| Low coated | 73 c | 5.68 | 29.92 a | 8.78 b | 113 a |
| CuSO₄ | | | | | |
| Uncoated | 57 d | 5.55 | 30.04 a | 8.60 c | 113 a |
| CuSO₄ | | | | | |

| | | | | Total | Chlorophyll |
|---|---|---|---|---|---|
| | Turbidity | Cu | Blue-green | algae | a |
| Treatment | (NTU) | (μg/L) | (cell/mL) | (cell/mL) | (μg/L) |
| Control | 100 | 6.6 a | 130,586 | 213,433 | 118 |
| High coated | 21 a | 13.2 c | 45,198 a | 78,783 a | 46.0 a |
| CuSO₄ | | | | | |
| Low coated | 23 a | 8.4 b | 74,078 a | 86,934 a | 56.8 a |
| CuSO₄ | | | | | |
| Uncoated | 15 a | 18.8 d | 61,877 a | 79,351 a | 42.4 a |
| CuSO₄ | | | | | |

The water temperature was similar among the control ponds and the treatment ponds at all sampling intervals (FIG. 1). However, when the grand means were compared, the control ponds had average temperatures of 0.90 to 1.03° C. less than the treatment ponds (Table 2). These differences were likely related to the control ponds being shallower than the treatment ponds and thereby losing proportionally more heat at night.

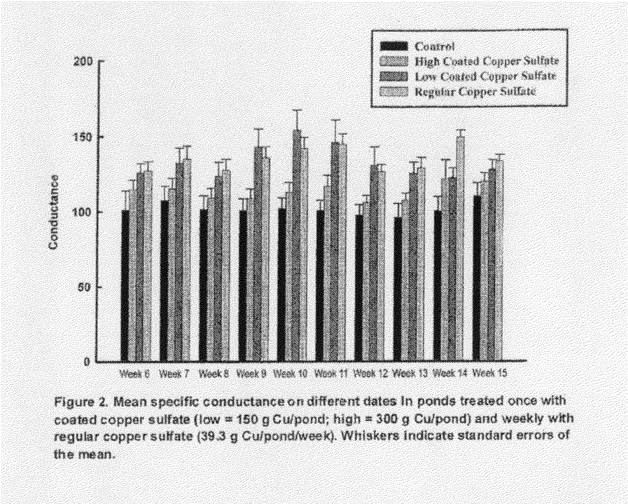

Specific conductance (Table2, FIG. 2) was slightly less in the control ponds than in the treatment ponds. No explanation for this difference is provided, but the amounts of copper sulfate applied to the treatment ponds were not enough to measurably influence specific conductance.

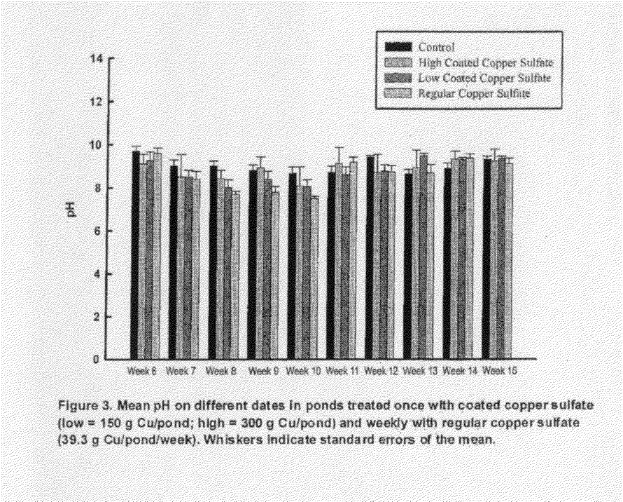

The pH did not vary greatly among the control ponds and the treatment ponds on any sampling intervals (FIG. 3), but the grand means for the control ponds were higher than the grand means of the copper treatment ponds. Ponds treated with the coated copper algaecide treatments did not differ in mean pH, but they had higher mean pHs than ponds treated with uncoated copper sulfate (Table 2).

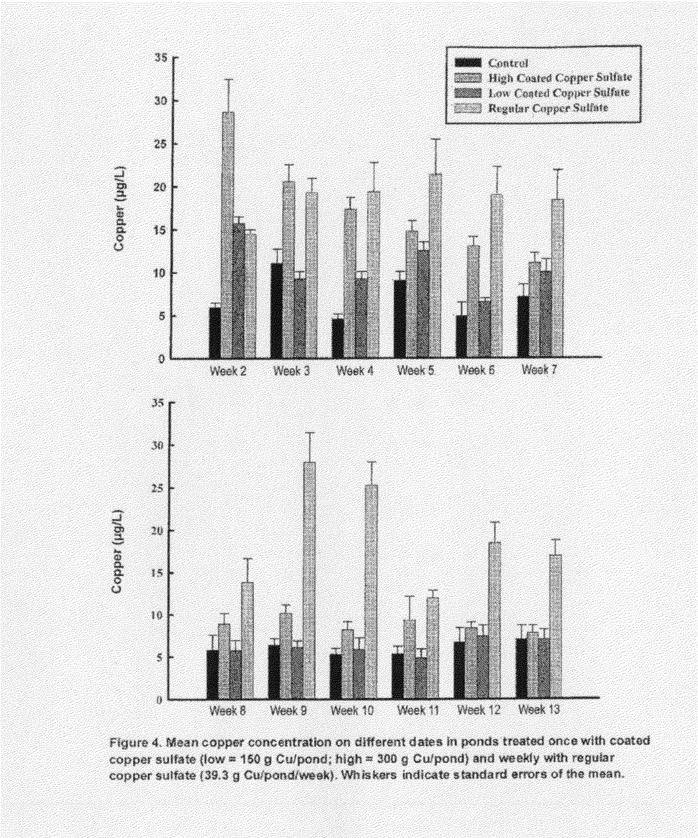

The copper concentration was much higher in the copper sulfate-treated ponds (treatment ponds) than in the control ponds throughout the study (FIG. 4). The coated copper sulfate-treated ponds had higher copper concentrations than the control ponds until Week 8 in the low treatment ponds and until Week 13 in the high treatment ponds. The grand means of copper were higher in the copper-treated ponds than in the control ponds (Table 2). However, the application of uncoated copper sulfate treatment resulted in greater copper concentrations than occurred in ponds treated with coated copper sulfate. Of course, considerably more copper was applied to the ponds of the uncoated copper sulfate treatment than to the other copper-treated ponds. Ponds treated with the high coated copper sulfate treatment were higher in copper concentration than ponds treated with the low coated copper sulfate treatment.

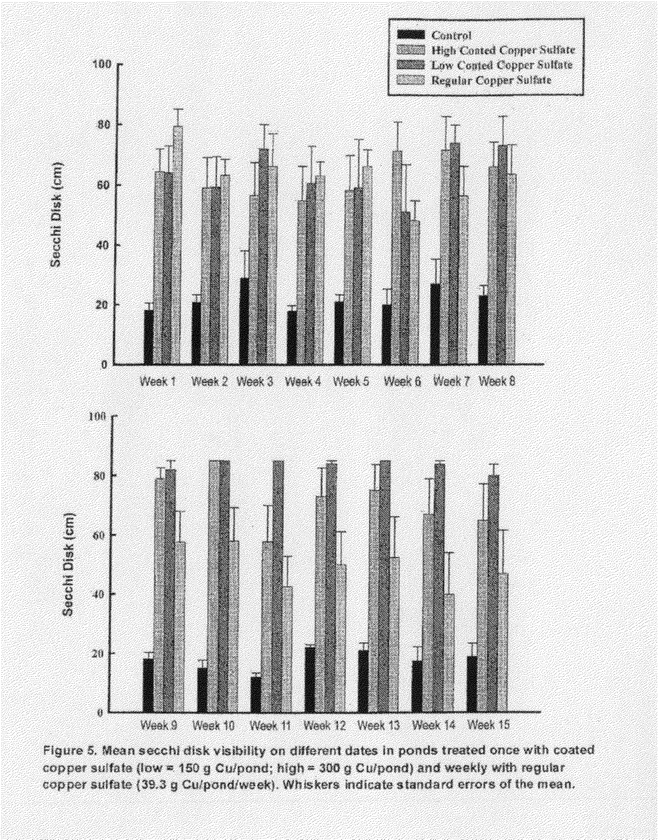

Phytoplankton abundance was estimated using the following four techniques: Secchi disk visibility, turbidity, chlorophyll a concentration, and total algal abundance. Secchi disk visibility was lower in the control ponds than in the treatment ponds throughout the study. This revealed that the treatment ponds had clearer water (and contained less phytoplankton) than the control ponds (FIG. 5). The ponds treated with the low coated copper sulfate treatment often had greater Secchi disk visibility than the ponds treated with either the high coated copper sulfate treatment or the uncoated copper sulfate treatment. There was no trend of differences in Secchi disk visibility between ponds treated with the high coated copper sulfate treatment and ponds treated with the uncoated copper sulfate treatment. The grand means for Secchi disk visibility differed among the control and the treatment ponds as follows: control<uncoated copper sulfate treatment<high coated copper sulfate treatment<low coated copper sulfate treatment (Table 2).

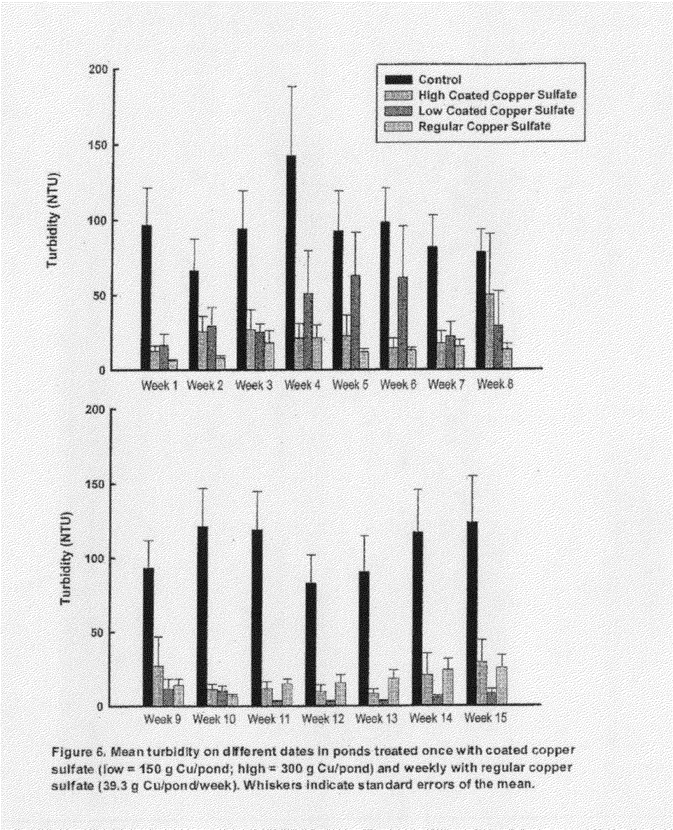

Turbidity was lower on all dates in the copper-treated ponds (treatment ponds) than in the control ponds, but turbidity levels fluctuated among treated ponds from date to date (FIG. 6). The grand means for turbidity in the control ponds was higher than the grand means of the treated ponds. However, the grand means for turbidity did not differ among ponds treated with the different copper treatments (Table 2).

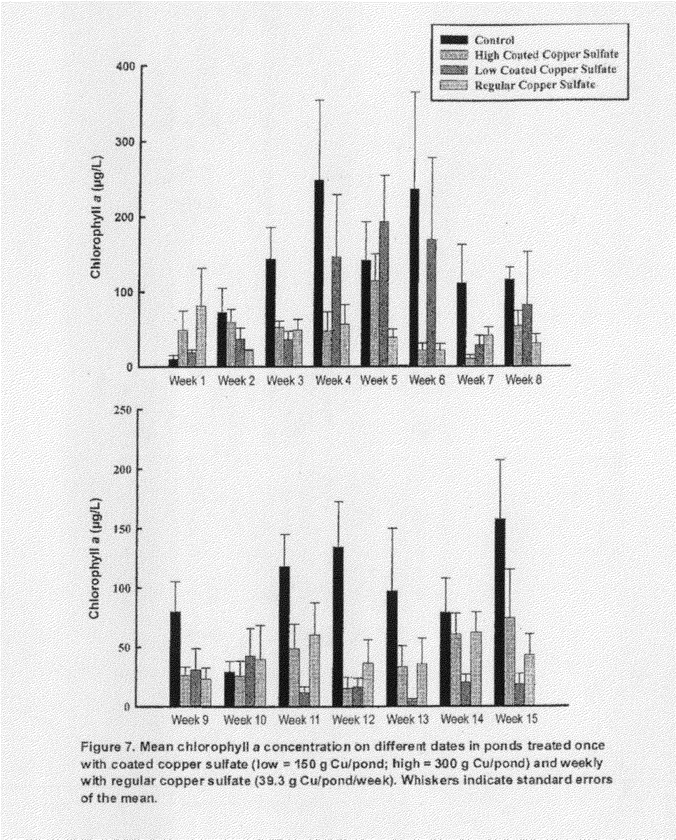

Chlorophyll a concentrations followed a trend similar to turbidity (FIG. 7). The grand means of chlorophyll a for the control ponds were greater than the grand means of the copper-treated ponds. The grand means for copper-treated ponds did not differ (Table 2).

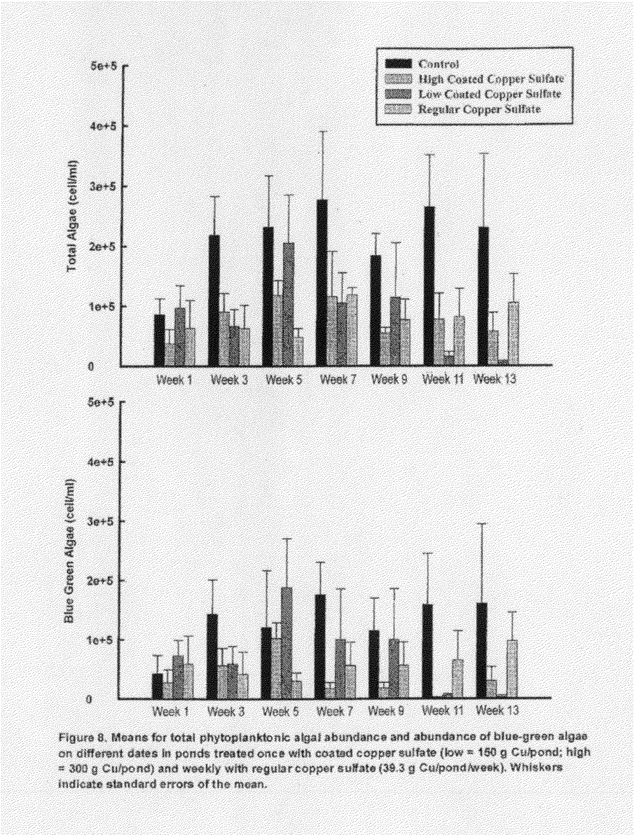

Total algal abundance revealed similar trends and differences among the control ponds and the treatment ponds as observed for chlorophyll a concentration (Table 2, FIG. 8). Blue-green algal abundance did not differ between the control ponds and the ponds treated with the low coated copper sulfate treatment (Table 2, FIG. 8), but ponds of the other two copper treatments contained less blue-green algae. There was no difference in blue-green algal abundance between ponds treated with the high coated copper sulfate treatment and ponds treated with the uncoated copper sulfate treatment. There also was no apparent difference in the types of blue-green algae in the treatment and the control ponds. Although several genera of blue-green algae were observed in the ponds, by far the most common and abundant genus was Anabaena. Species of this genus have been associated with geosmin, which is related to the off-flavor in fish at the E. W. Shell Fisheries Center.

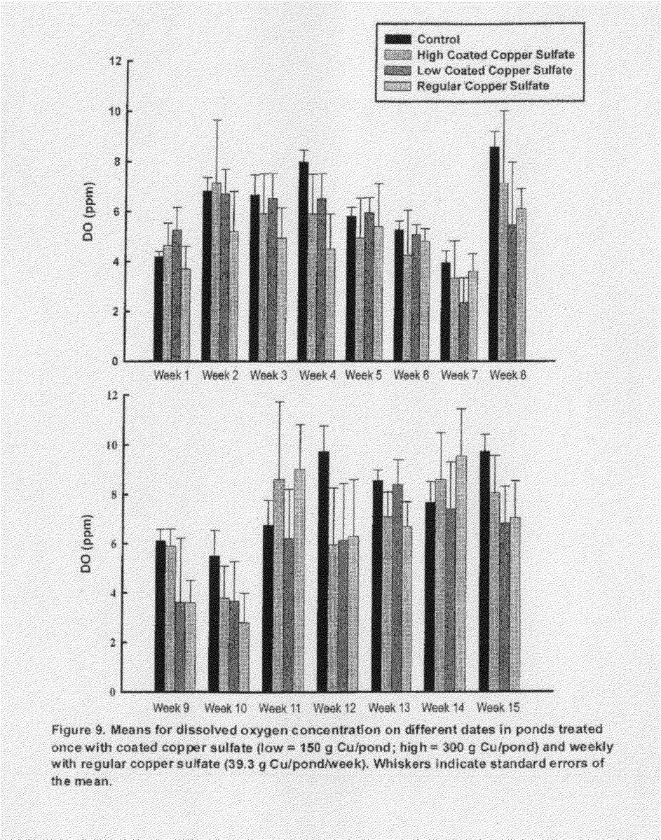

Dissolved oxygen concentration was always above 2 mg/L in the ponds despite the decision to not aerate, and mean dissolved oxygen concentrations usually were above 5 mg/L (FIG. 9). The grand means for dissolved oxygen concentration were higher in the control ponds than in the treatment ponds. However, there were no differences in dissolved oxygen concentration among ponds treated with the three different copper treatments (Table 2).

The mean copper concentration in the control ponds varied from 4.6 to 11.1 μg/L during the study. Moreover, on individual sampling dates, there was variation in the copper concentration among the five, replicate control ponds. For example, at Week 4, the copper concentration varied from 2.8 μg/L to 6.3 μg/L. On the same date, a similar variation also was observed in the treatment ponds; the copper concentration ranged from 12.9 μg/L to 21.1 μg/L in the high-rate, coated-product treatment. The variation possibly resulted from several sources including: copper contamination of sampling bottles, analytical error, and changes in conditions in the ponds that affected copper concentration. However, the variation in copper concentrations was no greater than the amount of variation typically encountered in measurements of other water quality variables in the ponds.

The control ponds and ponds treated with the uncoated copper sulfate exhibited great differences in copper concentration on all dates. The differences ranged from 6.6 to 20.0 μg/L. The weekly treatment rate of copper sulfate was equal to a copper concentration of 98 μg/L, but the total input of copper to a pond of the uncoated copper sulfate treatment was equivalent to 1,372 μg/L. However, at the end of the study, copper concentration in ponds of the uncoated copper sulfate treatment averaged only 16.94 μg/L. The rapid and large disappearance of copper from the water was not unexpected, because earlier studies showed that copper applied to the ponds is either adsorbed by phytoplankton, precipitated from water as copper oxide, deposited in sediment as organically-bound copper in dead phytoplankton, or adsorbed directly by sediment.

Ponds treated with the uncoated copper sulfate had copper inputs more than three-fold greater than those of the ponds treated with the low rate of coated product, and almost twice that of the ponds treated with the high rate of coated product. The mean copper concentrations were understandably lower on most dates in the ponds treated with the coated product. However, on the first date that the copper concentration was measured (13 days after copper treatments were initiated), the high rate of the coated product caused a much greater copper concentration than observed in the ponds treated with uncoated copper sulfate. Moreover, the ponds receiving a low rate of coated product had copper concentrations equal to those measured in the ponds treated with the uncoated copper sulfate treatment. At Week 3, the copper concentration was approximately equal in the ponds receiving a high rate of the coated product than those treated with the uncoated copper sulfate. On this date, the ponds treated with the low rate of coated product had less copper than the ponds treated with uncoated copper sulfate. After Week 3, the ponds with uncoated copper sulfate treatment had a higher copper concentration than found in the ponds to which the coated product was applied. After Week 8, the ponds treated with the low rate of the coated product had copper concentrations approximately equal to those of the control ponds. There was a clear elevation of the copper concentration in the ponds receiving the high rate of the coated product until Week 12.

At Week 10, bags containing the coated copper product were removed from one pond receiving the high rate of the coated product. The mesh of the bags was not clogged with debris that would have interfered with copper release to the water. However, when the particles of the coated product were observed and handled, it was obvious that nearly all of them were empty shells. The copper sulfate had completely dissolved. This suggests that the coating thickness for the copper sulfate was sufficient to control copper release for about 10 weeks.

Excellent phytoplankton control was achieved using the coated product. Based on the grand means for the four indicators of phytoplankton abundance (Table 2), both rates of coated product were statistically indistinguishable from the uncoated copper sulfate treatment. Moreover, phytoplankton did not rapidly re-grow in the ponds treated with the coated copper product for at least 1 month after copper sulfate had dissolved from the granules. About one month after the study was concluded, phytoplankton blooms had become re-established in ponds that had been treated with coated copper product at both rates.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1-42. (canceled)

43. A controlled release algaecide comprising: a copper sulfate granule coated with at least one layer including polyurethane.

44. The controlled release algaecide of claim 43, wherein the polyurethane comprises a reaction product of a polymeric diisocyanate and a polyol.

45. The controlled release algaecide of claim 44, wherein the polymeric diisocyanate is polymeric methylene diphenyl diisocyanate.

46. The controlled release algaecide of claim 44, wherein the polyol is a polyester polyol or a vegetable oil derived polyol.

47. The controlled release algaecide of claim 43, wherein the coating further comprises at least one layer comprising a precipitated silica parting agent.

48. The controlled release algaecide of claim 43, wherein the coating further comprises at least one layer comprising a wax.

49. The controlled release algaecide of claim 43, wherein the coating is present in amount ranging from about 15 wt. % to about 25 wt. %

50. The controlled release algaecide of claim 43, wherein the coating is present in an amount of about 20 wt. %.

51. The controlled release algaecide of claim 43, wherein the controlled release algaecide is effective in controlling a growth of phytoplankton, including blue green algae, over a period of time of at least three weeks.

52. The controlled release algaecide of claim 43, wherein the controlled release algaecide is effective in controlling a growth of phytoplankton, including blue green algae, over a period of time of up to about ten weeks.

53. The controlled release algaecide of claim 43, wherein the controlled release algaecide is effective in controlling a growth of phytoplankton, including blue green algae, over a period of time of up to about six months.

54. A method of manufacturing a controlled release algaecide comprising:
a) heating copper sulfate granules to a temperature of about 150° F.;
b) contacting the granules with a polymeric diisocyanate;
c) contacting the granules with a polyol, wherein the polymeric diisocyanate and the polyol react to begin to form at least one layer of a controlled release coating; and
d) contacting the granules with an additional amount of the polymeric diisocyanate to complete the formation of at least one layer of a controlled release coating.

55. The method according to claim 54, further comprising contacting the granules with a parting agent.

56. The method according to claim 54, further comprising contacting the granules with a wax.

57. The method according to claim 54, further comprising repeating steps a)-d) to form at least one additional layer.

58. A method of controlling phytoplankton growth in a body of water comprising:
suspending a porous container containing a controlled release algaecide below a surface of the body of water, wherein the controlled release algaecide comprises a copper sulfate granule coated with a coating having at least one layer including a polyurethane comprising a reaction product of a polymeric diisocyanate and a polyol; and
maintaining the porous container containing the controlled release algaecide in the body of water for at least one week, up to about ten weeks, or for a time period of up to six months.

59. The method according to claim 58, wherein the body of water is any one of a lake, pond, wetland, ornamental pond, swimming pool, cistern, drinking water reservoir, irrigation water reservoir, water treatment reservoir, rice production system, or irrigation canal.

60. A food product comprising:
one or more food products derived from a fish or shellfish raised in an aquaculture pond treated with a controlled release copper sulfate algaecide to prevent an off-taste.

61. The processed food product of claim 60, wherein the controlled release algaecide comprises a copper sulfate granule coated with a coating having at least one layer including a polyurethane comprising a reaction product of a polymeric diisocyanate and a polyol.

62. The processed food product of claim 60, wherein the fish or shellfish comprises any one of catfish, salmon, tilapia, or shrimp.

63. A method of controlling phytoplankton growth in a body of water, the method comprising contacting the body of water with a coated copper sulfate granule to control phytoplankton growth for at least one week, up to about ten weeks, or up to about six months, wherein the coated copper sulfate granule has at least one polyurethane layer comprising a reaction product of a polymeric diisocyanate and a polyol.
